(19) United States
(12) Patent Application Publication
(10) Pub. No.: US 2013/0305972 A1
(43) Pub. Date: Nov. 21, 2013

(54) LOW-RANK COAL PROCESSING APPARATUS AND METHOD

(71) Applicants: Chao Hui Chen, Crawley (GB); Michael John Smith, Crawley (GB)

(72) Inventors: Chao Hui Chen, Crawley (GB); Michael John Smith, Crawley (GB)

(73) Assignee: DOOSAN POWER SYSTEMS UK LIMITED, Crawley (UK)

(21) Appl. No.: 13/989,980

(22) PCT Filed: Nov. 25, 2011
(86) PCT No.: PCT/GB2011/052319

§ 371 Date: Aug. 9, 2013

(30) Foreign Application Priority Data
Nov. 25, 2010 (GB) 1020001.2

(51) Int. Cl. F23K 1/04; F23K 3/02; F26B 17/10

(52) U.S. Cl. CPC F23K 1/04; F26B 17/101; F23K 3/02
USPC 110/342; 34/578; 110/228; 110/234; 34/360

(57) ABSTRACT

An apparatus for the simultaneous drying and transport of low-rank coal is described. The apparatus has a first pipe having an inner wall surface surroundingly defining a first flow channel and an outer wall surface; a low-rank coal supply system to supply particulate low-rank coal to an inlet of the first flow channel; a transport gas supply to supply transport gas to an inlet of the first flow channel; a heating apparatus to apply heat to an outer wall surface of the first pipe along at least part of the length thereof for example in the form of a drying fluid supply to supply a drying fluid, configured such that a drying fluid is brought into contact with the outer wall surface of the first pipe along at least part of the length thereof. A system of design of thermal power plant incorporating such an apparatus is also described. A method for the simultaneous drying and transport of low-rank coal is also described. A system and method for supplying dried low-rank coal for combustion are also described.

### CROSS REFERENCE TO RELATED APPLICATIONS

This application is a National Stage of International Application No. PCT/GB2011/052319 filed Nov. 25, 2011, claiming priority based on British Patent Application No. 1020001.1 filed Nov. 25, 2010, the contents of all of which are incorporated herein by reference in their entirety.

### BACKGROUND

1. Field

The invention relates to an apparatus and method for the processing of low-rank coal, for example for use in a combustion apparatus, for example in a thermal power generation plant, and to a combustion apparatus, for example a thermal power generation plant, incorporating the same. The invention in particular relates to a low-rank coal drying process. The invention in a preferred case relates to a combined low-rank coal drying and transportation process. The invention also relates to a pulverized fuel delivery and burner injection system for a particulate low-rank coal fuel.

2. Description of the Related Art

Thermal power plant driven by coal combustion remains a major source of generation of electrical power. Low-rank coals are characterised by higher fuel moisture content (typically 25 to 60%, sometimes as high as 66%). High fuel moisture content is costly for a coal fired power plant. It leads to higher plant capital cost and lower efficiency as well as higher CO2 emissions as more fuel is needed per kWhe. There are vast low-rank coal reserves in Europe, America, Australia and Asia.

The high moisture content of low-rank coal means that large amounts of water vapour are generated during combustion. This generated vapour may be seriously detrimental to the efficiency of the combustion process. A high water vapour content in the boiler flue gas represents a high latent heat input that is not recoverable. Also, this can create requirements for larger plant, and especially for larger boilers, that are further detrimental to efficient operation and/or otherwise costly or undesirable. It is therefore important to reduce the moisture content prior to combustion.

In conventional low-rank coal power plants the fuel is dried using hot flue gas sucked from the furnace at a temperature of 900 to 1000° C. and conducted to the beater wheel mills, where a combined drying and pulverizing process is carried out. The vapour evaporated from the low-rank coal will be introduced to the furnace together with the pulverized fuel. The plant thermal efficiency is compromised mainly for the two reasons below:
1. Using high temperature energy for low temperature drying process is thermally inefficient.
2. Significant latent heat of the vapour generated from the low-rank coal drying process is not recovered.

Drying low-rank coal with a lower temperature energy resource is a more energy effective way to improve plant thermal efficiency. A significant current technology for lignite drying is the WTA technology developed by RWE Power as exemplified for example in US Patent Publication 2010/212320.

In such a system the pulverizing and drying processes are separated. Lignite is first pulverized in a crushing and milling apparatus and then passes to a fluidized bed dryer using low temperature steam as a source of lower grade thermal energy for drying. The resultant vapour is separated from the pulverized fuel and introduced to a condenser to recover the latent heat, and the dried lignite is removed from the dryer, cooled, passed for secondary milling if required and onward processed.

Such plant, by using lower grade heat from lower temperature steam for drying, is more energy effective. Moisture content may be reduced to around 10 to 20%. Further advantages accrue from using steam rather than hot gas drying including its ability to provide an inert atmosphere. Also, latent heat is easily recovered. However the capital cost of such plant can be very significant. In particular, the need to provide large fluidized bed dryers requires significant plant investment.

A further consideration for plant operation is transportation of the coal from source to a processing site such as a combustion site. Conventionally the coal is supplied from a coal yard, or possibly directly from a coal mine, located some distance remotely from a delivery site for example at its end processing site, which is for example its combustion site in the boilers of a thermal power plant. Conventionally the raw coal is conveyed from the coal yard or coal mine to coal silos associated with milling plants more closely adjacent its end processing site, and for example to the boilers of a thermal power plant, by conveying belts. The dust control of the coal conveying system is always an issue as the belts are open to the ambient. Normally, the plant coal silos are located at a higher level as there are coal feeders and mills arranged underneath. The conveying belts can only transport the solids to a higher position without an excessive incline. For supporting and housing the conveying belts, an enclosed bridge without excessive incline needs to be built for the complete length of conveying belts. The costs of the complete conveying system including the enclosed incline bridge are also significant.

### SUMMARY

It is generally desirable to improve the efficiency and cost-effectiveness of the drying and/or transport processes in plant such as thermal power generation plant which makes use of low-rank coal in a combustion apparatus.

In accordance with the invention in a first aspect, an apparatus for the processing of low-rank coal to remove moisture content therefrom comprises:

a first pipe having an inner wall surface surroundingly defining a first flow channel and an outer wall surface;

a low-rank coal supply system to supply particulate low-rank coal to an inlet of the first flow channel;

a transport gas supply to supply transport gas to an inlet of the first flow channel;

a heating apparatus comprising a source of heat and a means to apply the heat to an outer wall surface of the first pipe along at least part of the length thereof.

Thus, the apparatus of the invention comprises at least a first closed pipe which has a continuous closed wall to define an inner pipe volume in familiar manner. The wall of the first pipe has an inner wall surface which surroundingly defines an inner, first flow channel and an outer wall surface.

A supply of particulate low-rank coal is provided to an inlet of the first flow channel in combination with a transport gas supply in such manner, and in particular in such proportion and with such transport gas pressure/velocity, that a fluidised mixture is formed which is transportable along the first flow channel in use.

The apparatus is distinctly characterised by the provision of an external heat source in the form of the heating apparatus which applies thermal energy indirectly to the first flow channel via the pipe wall. This provides the primary source of thermal energy for drying the fluidised low-rank coal in the first flow channel. The invention does not preclude a degree of drying function being provided by the transport gas, but is distinctly characterised in the provision of a drying function, indirectly through the wall of the first pipe, from thermal energy supplied by the heating apparatus.

The apparatus of the invention thus forms an elongate fluid conveyance means in which an elongate first flow channel containing low-rank coal that is being both dried in and conveyed along the length of the first flow channel is in thermal communication with but fluidly separate from a primary heat source provided by the heating apparatus.

A particular advantage of the invention may be seen in that the processing apparatus, in that it defines an elongate process flow channel through which low-rank coal that is being both dried and conveyed passes, may improve the efficiency and cost-effectiveness of the drying and transport processes by providing for what is at least in part an integrated system to perform both functions. The drying apparatus of the invention is not a discrete dryer unit into which wet pulverous low-rank coal is first conveyed for drying by an entirely separate supply conveyor, and out of which dried pulverous low-rank coal is then conveyed for onward processing by an entirely separate delivery conveyor. It is a drying apparatus which may itself also serve as a conveying apparatus serving to perform at least in part the role of the supply conveyor and/or delivery conveyor in a conventional plant arrangement.

The apparatus thus comprises a first pipe having an inner wall surface surroundingly defining a first flow channel and an outer wall surface; the first flow channel having an inlet at a first end in the vicinity of a low-rank coal supply source and an outlet at a second end remotely spaced therefrom, and for example at another part of the plant, in the vicinity of a low-rank coal delivery site;

a low-rank coal supply system to supply particulate low-rank coal to an inlet of the first flow channel;

a transport gas supply to supply transport gas to an inlet of the first flow channel and convey the particulate low-rank coal to an outlet remotely spaced therefrom;

a heating apparatus comprising a source of heat and a means to apply the heat to an outer wall surface of the first pipe along at least part of the length between the inlet and the outlet so as to effect drying of the particulate low-rank coal as it is conveyed from the first end to the second end.

The apparatus thus serves at least in part both as a means to effect drying of the low-rank coal and as a means to convey the low-rank coal from the supply source to the delivery site. The supply source may be remotely located some substantial distance from the delivery site for example in another part of the plant. The apparatus of the invention preferably comprises an elongate process flow channel through which is passed low-rank coal that is being both dried and conveyed that extends at least a substantial part, and for example a major part, of the distance between the supply source and the delivery site in a low-rank coal processing plant such as a low-rank coal combustion plant. The pipe or pipes of the apparatus of the invention are configured accordingly. The delivery site may be tens of metres away for example at least 100 m away and for example several hundreds of metres away or more. Consequently, the processing apparatus comprises an elongate process flow channel through which low-rank coal that is being both dried and conveyed that is at least 100 m long and may be several hundreds of metres long up to several kilometers long.

In this way, the apparatus of the invention offers potential efficiency both in that the drying and conveying functions may be consolidated and in that large bespoke dryers such as are found in the prior art may be at least partly dispensed with and/or more conveniently located within the plant.

Additionally, in the preferred case the process flow channel through which low-rank coal that is being both dried and conveyed passes may be substantially isolated from the external environment. That is, the apparatus comprises a first pipe having an inner wall surface surroundingly defining a first flow channel in such manner as to substantially isolate the first flow channel from the external environment for the length of the first pipe. The conveying system may thus be more environmentally convenient than the large scale open conveyors in the prior art.

The heating apparatus may be any suitable apparatus to supply thermal energy from a heat source to an outer wall surface of the first pipe along at least part of the length thereof. The heat source may be a source of radiant and/or conducted heat. Suitable heat sources might include resistance heater elements and/or hot pipes disposed along and/or around the first closed pipe wall.

In a possible embodiment the heating apparatus includes a drying fluid supply to supply a drying fluid, configured such that in use a drying fluid is brought into contact with the outer wall surface of the first pipe along at least part of the length thereof.

In this embodiment a drying fluid is supplied in such manner as to contact with and in the preferred case to flow over the outer wall surface of the first pipe, for example along and/or around the pipe, for at least a part of its length. The relative thermodynamic conditions of the drying fluid and transport gas are selected such that thermal energy tends to transfer from the former to the latter across the wall surface of the first pipe, from sensible and/or latent heat in the drying fluid. The sensible and/or latent heat in the drying fluid provides the primary source of thermal energy for the drying of the low-rank coal within the first pipe.

In a preferred configuration the drying fluid supply comprises a drying fluid conduit adapted to cause drying fluid to flow along the outer wall surface of the first pipe along at least a part of its length and drying fluid source supply to supply a drying fluid to an inlet of the drying fluid conduit.

For example in a preferred embodiment the drying fluid supply comprises:

a second pipe surroundingly disposed around the first such that an inner wall of the second pipe and an outer wall of the first pipe together define a second flow channel;

a drying fluid source supply to supply a drying fluid to an inlet of the second flow channel.

Thus, the apparatus of the invention in a preferred embodiment comprises a first closed pipe disposed entirely within the inner volume of a second closed pipe. Each pipe has a continuous closed wall to define an inner pipe volume in familiar manner. The wall of the first pipe has an inner wall surface which surroundingly defines an inner, first flow channel and an outer wall surface. The second pipe similarly has an inner wall surface and an outer wall surface in conventional manner. Because the first pipe lies entirely within the volume defined by the inner wall surface of the second pipe, the inner wall surface of the second pipe and the outer wall surface of the first pipe together define at least one second flow channel disposed outside and around the inner first flow channel.

The pipes making up the apparatus together thus form a composite elongate fluid conveyance means in which an elongate first flow channel is surrounded by but fluidly separate from an elongate second flow channel. This distinctive arrangement of paired flow channels is fundamental to the drying process of the preferred embodiment of the invention. Subject to this general principle, no reference to, or exemplification by, a single first flow channel and a single second flow channel should be understood as limiting the invention to exclude cases where either the first flow channel or, where applicable, the second flow channel is partitioned into a plurality of fluidly separate sub-channels whether by the provision of partitions, multiple pipes or otherwise.

Inlet means may be provided to each respectively defined flow channel at an inlet end of the fluid conveyance means. Outlet means may be provided at a remotely spaced outlet end. The inlet means are adapted to receive supply of low-rank coal to be dried from a supply source and the outlet means are located to deliver dried low-rank coal to a delivery site for further processing and for example for combustion. In the particular preferred case the supply source may be remotely located some substantial distance from the delivery site for example in another part of the plant.

Transport gas may be recovered after use at a transport gas outlet of the first flow channel remotely spaced from the transport gas inlet of the first flow channel, for example comprising such outlet means. A heat recovery system to recover latent heat from the transport gas so recovered is preferably provided, for example in fluid communication with such outlet means.

The present invention relates to the processing by drying, especially for combustion, of low-rank coals, which term is used herein to refer to those coals, including coals sometimes called lignites, brown coals, or sub-bituminous coals, which have a higher fuel moisture content (typically 25 to 60%, sometimes as high as 66% or more) than bituminous coals. In particular, the invention relates at least to drying of such coals, especially for combustion, for example in a thermal power plant.

It is a particular advantage of the apparatus of the invention that it is able in the preferred application in the thermal power plant to make use of sources of low grade heat, and in particular of sources of lower temperature steam, to facilitate the drying process with the attendant overall efficiency advantages. However, in contrast to the prior art, a fluidised bed arrangement is not used. Instead, at least a substantial part of the drying process is effected by the supply of a drying fluid which is supplied to make contact with the outer wall of the first flow channel, for example in the preferred case by flowing through the second flow channel, and thereby provides thermal energy indirectly to the particulate low-rank coal flowing in the first flow channel.

Thus, the apparatus of the present invention does not require large fluidised bed dryers. Instead, heat transfer takes place at least in large part across the inner pipe wall from heat applied via the heat source to the outer surface of the inner pipe wall and in the preferred case from the drying fluid in contact with the outer surface of the inner pipe wall. Not only does this potentially reduce the complexity and scale of the structure, but it allows a significant further advantage in practice in that it allows the drying and conveying processes to be combined. In this preferred case the volume defined by the inner pipe serves both as a drying volume in which the low-rank coal is dried and as a conveyance channel through which the low-rank coal is effectively pneumatically conveyed from the inlet end to the outlet end of the pipe.

The transport gas may for example comprise steam.

Where a drying fluid is supplied this is conveniently a drying gas. The drying fluid source supply is thus conveniently adapted to supply a drying gas. The drying gas may for example comprise steam.

In accordance with a preferred embodiment of the invention, a low-rank coal conveying process and a drying process that can utilize low temperature energy may be integrated together in a conveying system, for example with steam trace heating using steam as a drying gas. The inner flow channel is used for the pneumatic conveying of particulate low-rank coal. A drying fluid supply configured such that a drying fluid is brought into contact with the outer wall surface of the first pipe for example comprising an outer flow channel as above described carries low grade steam to supply the thermal energy. This arrangement can produce the energy effectiveness of a drying process making use of low temperature energy with potential reduced cost and footprint, and with an environmentally friendly conveying system and hence low-rank coal plant.

In a convenient embodiment the drying fluid supply comprises a supply source for the supply of steam as a drying gas, for example being by-product of an industrial process such as low grade steam from a thermal power plant.

In a convenient embodiment the transport gas supply comprises a supply source for the supply of steam as a transport gas, for example being by-product of an industrial process such as low grade steam from a thermal power plant.

In a case where steam, for example low grade steam from a thermal power plant, is used as a transport gas and a drying gas, the apparatus is adapted to maintain pressure of the drying gas higher than pressure of the transport gas so that the saturation temperature of the drying gas is higher. Accordingly, the thermal transfer process across the wall of the first pipe makes use of the latent heat of the drying gas steam as it condenses on the wall of the first pipe and not merely the sensible heat.

In operation there will necessarily be a pressure drop along the length of a fluidly continuous first, inner pipe from the inlet to an outlet end. In the preferred case where the invention is applied to convey particulate low-rank coal a substantial distance within a site whilst drying it, for example from a supply source remotely located some substantial distance from a delivery site for example in another part of the plant, this effect may be substantial. Provided the above overpressure is maintained, the drying fluid supply apparatus, in the preferred case in conjunction with an outer pipe, may be adapted to apply a reduced pressure of drying fluid along the length of the fluidly continuous inner pipe from the inlet to an outlet end. In a possible embodiment, the drying fluid supply apparatus may comprise a plurality of successive drying fluid supply modules disposed successively along the length of the fluidly continuous first, inner pipe, for example adapted for successively reduced pressure of operation. In the preferred case, a plurality of successive fluidly separate outer pipe modules may be disposed around a fluidly continuous inner pipe adapted for successively reduced pressure of operation.

The cross-sectional area of a pipe may be constant along its length or may vary, for example having a cross-sectional taper or flare, to control pressure and velocities, in particular changing from a smaller cross-sectional area towards an inlet end to a larger cross-sectional area towards an outlet end.

It is an essential feature of the invention that thermal transfer takes place through the wall of the inner pipe to enable thermal energy from an indirect heat source which is in an example embodiment a drying fluid to be transferred to and dry the particulate low-rank coal within the first flow channel. Material selection of the inner pipe will be optimised accordingly.

Low-rank coal is conveyed in the inner transport pipe and dried in particulate form. Thus, the low-rank coal is pulverised to a suitable particulate size prior to its supply to an inlet of the first flow channel. Thus, the apparatus preferably further comprises a milling apparatus to reduce a low-rank coal stock to a suitable particulate size, upstream of but in communication with the low-rank coal inlet of the first flow channel, and for example upstream of or in combination with the low-rank coal supply means.

In one possible case, the low-rank coal is pulverised prior to transportation down to a particulate size that is itself already suitable for the intended onward process, and for example for combustion, so that is can be directly conveyed for that onward process, such as for combustion, from the outlet of the first flow channel.

In an alternative case, particulate size is optimised for transport and further reduced subsequently for onward processing such as combustion. In this case, a first milling apparatus is provided upstream of the inlet of the first flow channel and a further milling apparatus is provided downstream of the outlet of the first flow channel.

In the preferred embodiment comprising inner and outer pipes each of the outer and inner pipes defines a volume for the transport of a fluid, in particular under pressure. Each pipe therefore comprises a closed and fluid-tight wall. The design parameters of the pipes will follow familiar principles, and will be determined by operational pressures and temperatures. In a particular embodiment, a transport gas pressure of 2 to 30 bar may be appropriate. Pressure in the outer flow channel will typically be higher than pressure in the inner flow channel. Materials will be selected accordingly.

The pipes in the preferred embodiment together form an elongate conduit for the pneumatic conveyance and simultaneous drying of particulate low-rank coal. Pipe geometries are not specifically pertinent to the invention. Each pipe wall defines a closed perimeter which may for example be a closed curve or a polygon. The shapes of the inner and outer pipes may be similar or dissimilar. In a preferred case the two pipes are similar in shape and arranged concentrically, and particularly conveniently are co-axially arranged circular pipes. In accordance with such an arrangement, the inner flow channel is a circular flow channel defined by the first pipe and the outer flow channel is an annular flow channel defined in the gap between the outer wall surface of the first pipe and the inner wall surface of the second pipe.

Each of the first and second flow channels may comprise single fluidly continuous flow channels, or by being sub-divided for example by partitions in a longitudinal pipe direction or by provision of multiple parallel pipes or otherwise may comprise a plurality of longitudinally extending sub-channels without departing from the scope of the invention.

To assist in thermal transfer of heat to the low-rank coal in the inner flow channel in use, wall surfaces of the inner pipe may be modified by provision of heat transfer structures which act to increase the surface area for heat transfer.

This may be particularly appropriate where a drying fluid is used as a heat source. Heat transfer structures are preferably provided on the outer wall surface of the inner pipe for example extending into the second flow channel containing the drying fluid in use. In a preferred mode of operation latent heat is recovered by condensation of steam from a saturated drying gas, and these structures are adapted to comprise condensation structures. For example, longitudinally extending radial vanes, radial pins or the like may be provided on the outer wall surface of the inner pipe for this purpose.

The inner wall surface of the inner pipe has a harsher erosion environment. High aspect ratio heat transfer structures may be less favoured. Nevertheless the inner wall surface of the inner pipe may be rifled or ribbed to modify flow characteristics and/or increase surface area to improve thermal transfer.

As noted above the apparatus in the preferred case serves at least in part both as a means to effect drying of the low-rank coal and as a means to convey the low-rank coal from the supply source to the delivery site. The supply source may be remotely located from the delivery site for example in another part of the plant.

For example the low-rank coal supply system may be or may be located in the vicinity of a mill to convert low-rank coal into particulate form for drying/transport. The apparatus of the first aspect of the invention may serve to convey pulverous low-rank coal, while drying the same, from this supply point to a delivery site remote therefrom, and for example to a suitable delivery system to store and/or deliver dried low-rank coal for onward processing. The delivery site may be a transit station including a storage silo and/or an end use site such as a combustion site.

The delivery site may thus be located remotely from the mill. The mill may be located at a coal yard and the delivery site may be located relatively much more closely to a processing site (for example a combustion site). The delivery site may be located substantially at the processing site. Thus, the milling takes place at the coal yard remote from rather than at or in the vicinity of the combustion or other processing site and the pulverous coal is conveyed from the coal yard via a combined transport and drying system in accordance with the invention. This can be contrasted with conventional systems where milling and drying typically take place at the combustion or other processing site, for example at the boiler front.

In a preferred case therefore the invention comprises a system to process low-rank coal to remove moisture content therefrom and simultaneously convey the same for a substantial part of the distance from a low-rank coal supply system to a remote delivery site.

In particular the system comprises an apparatus as above described defining a first flow channel in which low-rank coal is processed, the first flow channel having an inlet at a first end and an outlet at a second end remotely spaced therefrom;

a low-rank coal supply system to supply particulate low-rank coal to an inlet of the first flow channel;

a low-rank coal delivery system to receive dried particulate low-rank coal from an outlet of the first flow channel.

The low-rank coal supply system may include and/or may be located in the vicinity of and in communication with a mill to convert low-rank coal into particulate form for drying/transport.

The low-rank coal delivery system may include storage means and onward supply means to supply the dried particulate low-rank coal for further processing, for example prior to or at its end use site.

The low-rank coal supply system may be located remotely some distance from an end use site such as a combustion site. The low-rank coal delivery system may be located substantially more closely towards and for example generally in the vicinity of an end use site such as a combustion site. The system thus serves simultaneously to dry the low-rank coal and to convey the low-rank coal from a supply site located remotely some distance from an end use site towards the end use site.

In a more complete embodiment of processing system the above described apparatus for the processing of low-rank coal may be designed with the following systems in any combination:

a mill to convert low-rank coal into particulate form for transport;

a transit station including a particulate low-rank coal storage silo;

an apparatus in accordance with the first aspect of the invention adapted to transport the particulate low-rank coal from the mill towards the transit station;

a separator upstream of the transit station to separate particulate low-rank coal for storage from transport gas;

a recovery conduit for recovery of transport gas at the transit station.

The transit station may for example be located remotely from the mill. The mill may be located at a coal yard and the transit station may be located relatively much more closely to a processing site (for example a combustion site) for the processing of the dried low-rank coal. The transit station may be located substantially at the processing site. Thus, the milling takes place at the coal yard remote from rather than at or in the vicinity of the combustion or other processing site and is conveyed from the coal yard via a combined transport and drying system in accordance with the first aspect of the invention. This can be contrasted with conventional systems where milling and drying typically take place at the combustion or other processing site, for example at the boiler front.

Conveniently the system is adapted for drying of low-rank coal via a heat source in the form of a drying gas applied to the outer surface of the first pipe of an apparatus in accordance with the first aspect of the invention. Conveniently the system is adapted for drying of low-rank coal via steam trace heating. In a preferred application to supply fuel to a thermal power plant the system comprises a steam supply conduit to supply steam from a low grade source in the thermal power plant as a drying gas for the apparatus to transport the particulate low-rank coal.

Conveniently further steam is used as the transport gas and the system comprises a steam supply conduit to supply steam from a low grade source in the thermal power plant as a transport gas for the apparatus to transport the particulate low-rank coal.

The use of a combined conveying and drying system in the manner above described, especially making use of sources of low grade steam to provide at least a part of the thermal energy for drying, and thus to provide low grade steam as a drying gas, and conveniently additionally using low grade steam as a transport gas, offers a number of potential advantages for plant design. These arise in particular first from the fact that the conveying system is more environmentally convenient than large scale open conveyors and second from the fact that the ability to use process steam offers the potential for a number of efficiency savings, and for the recovery of a greater proportion of the latent heat from the moisture contained within the low-rank coal.

The first possible element of plant design concerns the mill. At the mill the low-rank coal is converted into particulate form suitable for transport in the inner flow channel of the transport system, and is for example pulverised to a point suitable for subsequent combustion. The mill preferably comprises of pulverising mill, for example one or more hammer mills in series.

In a possible embodiment, a drying apparatus may be provided in conjunction with the mill to effect some preliminary drying. Although most of the drying of the low-rank coal takes place in the transport system, some preliminary drying may be appropriate, for example to ensure that the low-rank coal may be fluidised effectively for transport. For example, some degree of surface drying may take place at this point, with the majority of the bulk drying taking place subsequently.

Pulverised low-rank coal is transported from the mill to a pulverised fuel store which may be several kilometers away via a transport system in accordance with the first aspect of the invention, in particular in the preferred case comprising first and second pipes defining first and second flow channels as above described. In a preferred design, process steam such as low grade steam from the thermal power plant is supplied to both the first flow channel as a transport gas and the second flow channel as a drying gas. The steam in the second channel is at an over-pressure relative to the first channel and as a result has a higher saturation temperature, so that thermal transfer from the second flow channel across the first pipe wall into the first flow channel occurs in large part as steam condenses on the outer wall of the first pipe, and transfer is effected of latent heat and not just sensible heat of the steam in the second flow channel. Condensation structures are preferably provided within the second flow channel, for example extending outwardly of the wall of the first pipe. Condensate sinks are provided in the second pipe.

The heat transfer coefficient for the steam trace heating from the steam in the outer flow channel should be quite high as steam condensing is involved in the heat transfer process. By contrast it is possible that the heat transfer coefficients from the inner pipe wall(s) to the inner transport flow(s) could be a bit low even in the preferred case of fluidised gas/solid flows. To optimize the design measures for heat transfer enhancement may be implemented to the transport flow side for a more intensive drying process.

One or more of the following measures might be considered amongst others.

Increases to the transport steam temperature and pressure may be considered. Of course, to retain adequate heat transfer, similar increases in temperature and pressure may be necessary to maintain over-pressure in the heating steam. Also, higher gas/solid velocities may create more erosion problems.

Indeed these aspects of the design are in general a matter of balancing the various parameters. In particular, design parameters need to control the pressure drop along the length of the inner flow channel. If the temperature of the transport steam is increased, there is a tendency to extract more moisture from the particulate low-rank coal in the transport stream.

Accordingly, as an optional additional design feature, either gradually or in stages along the fluidly continuous length of the transport pipe, the diameter may progressively enlarge.

Increases in the pressure differential of the heating steam and the transport steam may be employed to produce an increased temperature differential between the streams.

Use may be made of internally ribbed pipes for the transport stream. A rifled pipe may have a better heat transfer but a pipe with straight ribs should be less prone to the erosion attacks.

Use may be made of multiple transport pipes with smaller diameters to increase the heating surface area. This is also beneficial in minimising the impact caused by the failure of individual lines.

At the supply site, for example being the transit station, relatively dry fuel is separated from transport steam via a separator such as a cyclone separator system. This may comprise a single cyclone separator or, more preferably, two or more cyclone separators in series.

The separated transport flow, now comprising transport steam and also steam recovered from the low-rank coal drying process, may be recovered via a suitable recovery conduit, for example in the case of a thermal power plant to be supplied as process steam elsewhere in a thermal power plant so that more of the latent heat of the steam can be usefully recovered.

The temperature of the steam is likely to be the saturation temperature at outlet pressure. There may be a small degree of superheat. The recovered steam is passed to a suitable heat recovery system, for example passed via a condenser, to recover latent heat, for example in the case of a thermal power plant to boiler feed water or combustion air. Thus, the system recovers at least in large part the latent heat of the vapour which has been removed from the low-rank coal via the drying process. The system does not require very high temperatures to achieve this high degree of recovery of latent heat.

The pulverised fuel is preferably collected into coal bins or silos at the transit station. At this stage in the process this pulverised fuel is also hot. It is desirable not to lose this sensible heat when the pulverised fuel is transported to the burners.

In a more complete aspect, the invention comprises a combustion system for the combustion of low-rank coal supplied by the above described apparatus for the processing of low-rank coal. In particular, the apparatus may comprise a low-rank coal delivery system to deliver processed low-rank coal for combustion. The low-rank coal delivery system may include storage means such as a storage silo and onward supply means to supply the dried particulate low-rank coal either directly for combustion or for further processing into combustible form. The low-rank coal delivery system may include a transit station as above described.

In a more complete embodiment of combustion system, the system preferably further includes, downstream of the particulate low-rank coal storage silo, a means to transport the dried particulate low-rank coal to a combustion site for combustion, and for example comprises one or more burners at the combustion site for the combustion of the coal. For example the system preferably further includes, downstream of the particulate low-rank coal storage silo, a conveying conduit; and a conveying gas supply system to supply conveying gas to the conveying conduit in such manner as to entrain particulate low-rank coal and convey the same from the low-rank coal storage to a process site such as a combustion site for combustion.

In a more complete aspect, the invention comprises a steam generator wherein the means to generate steam comprises such a combustion apparatus.

In a more complete aspect, the invention comprises a thermal power generation plant including one or more steam generators in accordance with the previous aspect.

The main purpose of having a transit station is to provide the means to separate the vapour from the particulate low rank coal so that the latent of the vapour can easily be recovered. Another advantage of the use of a particulate low-rank coal storage silo is that it decouples the initial conveying/drying stage from coal yard to transit station from the conveyance and supply stage from transit station to final destination. This can offer particular advantages where the particulate low-rank coal is supplied to burners for indirect firing.

Burners of a coal-fired power plant are typically supplied by so-called direct injection. In direct injection pulverized fuel (PF) is pneumatically conveyed directly from the mill to the burners.

Conventionally PF is pneumatically conveyed to boiler burners in lean phase. The use of a PF silo to decouple the drying and transport process means that the PF need not be pneumatically conveyed to boiler burners in lean phase.

Accordingly, in a further aspect of the invention, a pulverized fuel delivery and burner injection system comprises:

a particulate low-rank coal storage silo;

a dense phase pneumatic conveyor system to convey particulate low-rank coal in dense phase from the silo to a combustion site;

one or more burners at the combustion site for the combustion of the coal;

a burner fuel injection system to supply each burner separately with coal at the combustion site from the dense phase conveyor system by direct injection.

In this aspect of the invention dry pulverized low-rank coal is delivered to coal burners of a furnace by dense phase pneumatic conveying. The coal is directly injected to the individual coal burners. Combustion air may be supplied via a windbox in conventional manner. The firing system is thus an indirect firing system using dense phase pneumatic conveying of the pulverized fuel with fuel injected at each burner.

The delivery and injection system in accordance with this aspect of the invention is in particular suited for use with the drying and transport system of the first aspect of the invention as an integrated drying transport and combustion solution, and is discussed below in that context. However the skilled person will appreciate that the use of a particulate low-rank coal storage silo decouples the two stages and means that each aspect has independent application. The drying and transport system of the first aspect of the invention may be used to deliver dried low-rank coals to a silo for any onward purpose, and if integrated into a combustion system may be used with any delivery and injection system. The delivery and injection system in accordance with this aspect of the invention may be supplied with particulate low-rank coal from the storage silo that has been processed and dried by any suitable apparatus.

The fuel is transported to the burners entrained in a conveying gas via a conveying system comprising one or more conveying conduits. The conveying gas may be air. The high oxygen content of air, given the presence of volatiles in low-rank coal and the possible high temperature might be less desirable. In the preferred case, hot flue gas is used.

In the conveying conduit the purpose of the conveying gas/solid mix is purely transport, and the gas solid ratio can be very high. The pipes may be very small.

For lean phase conveyance, diameters of PF pipes may be as large as 400 to 600 mm. The costs of the PF pipes including the supports for the piping are significant. These PF pipes occupy large space and cause difficulties to layout around burner areas. Large primary air (PA) fans are typically required.

In accordance with this aspect of the invention dense phase pneumatic conveying is used. The skilled person will appreciate the distinction between this process and lean phase conveying. In lean phase conveying gas to fuel ratios of 1.5 to 2.5 gas to 1 fuel by weight are typical. In the dense phase process of this aspect of the invention gas to fuel ratios may be much higher and are preferably in the range between 1 to 5 and 1 to 45 by weight, preferably in the range between 1 to 10 and 1 to 30.

With dense phase pneumatic conveying, the apparatus may comprise fuel conveying pipes with smaller diameters, for example below 200 mm for example as small as 30 to 80 mm.

Significant practical advantages might accrue. The smaller scale pipework alone is a potential simplification of the engineering involved. Large primary air fans may not be necessary. Air can be provided by the forced draft (FD) fans. Thus, in a preferred embodiment, forced draft fans are provided as the sole means to supply combustion air to the windbox and primary air fans are not provided. All this may result in significant cost reductions and much more desirable free space around the burner area for maintenance.

The conveying system may comprise in fluid series an upstream conveying conduit; a distributor comprising a pressure vessel with an inlet to receive fuel from the upstream conveying conduit and a plurality of outlets serving a corresponding plurality of downstream conveying conduits, each downstream conveying conduit having a fuel injection apparatus to inject fuel into one or more burners. A single distributor may feed a number of burners.

In a further aspect of the invention, a method for the processing of low-rank coal to remove moisture content therefrom comprises the steps of:

supplying particulate low-rank coal to an inlet of a first pipe having an inner wall surface surroundingly defining a first flow channel and an outer wall surface;

supplying a transport gas to an inlet of the first flow channel such as to cause the particulate low-rank coal to fluidize and flow along the first flow channel;

applying thermal energy to the outer wall surface of the first pipe along at least part of the length thereof such that transfer of thermal energy across the wall of the first pipe into the first flow channel tends to dry the particulate low-rank coal in the first flow channel.

In a preferred case the step of applying thermal energy comprises causing a drying fluid to contact with and for example flow over the outer wall surface of the first pipe along at least part of the length thereof under such thermodynamic conditions that thermal transfer from the drying fluid across the wall of the first pipe into the first flow channel from sensible and/or latent heat in the drying fluid tends to dry the particulate low-rank coal in the first flow channel.

In a further preferred case the method comprises the step of supplying a drying fluid to a second flow channel surroundingly disposed around the first pipe under such thermodynamic conditions that thermal transfer from the fluid in the second flow channel across the wall of the first pipe into the first flow channel tends to dry the particulate low-rank coal therein.

In a particularly preferred case the method is a method for the processing of low-rank coal to remove moisture content therefrom and simultaneously conveying the same from a supply source to a delivery site, in particular remotely located some distance from the supply source, the method comprising the steps of:

supplying particulate low-rank coal to an inlet of a first pipe having an inner wall surface surroundingly defining a first flow channel and an outer wall surface;

supplying a transport gas to an inlet of the first flow channel such as to cause the particulate low-rank coal to fluidize and flow along the first flow channel towards an outlet at a second end remotely spaced therefrom;

applying thermal energy to the outer wall surface of the first pipe along at least part of the length thereof such that transfer of thermal energy across the wall of the first pipe into the first flow channel tends to dry the particulate low-rank coal in the first flow channel as it moves along the first flow channel from the inlet to the outlet.

The first flow channel has an inlet at a first end in the vicinity of a low-rank coal supply source and an outlet at a second end remotely spaced therefrom, and for example at another part of the plant, in the vicinity of a low-rank coal delivery site. The method is thus a method to effect drying of the particulate low-rank coal as it is conveyed from the first end to the second end.

Further preferred features of the method will be understood by analogy with those discussed for the corresponding apparatus.

In a further aspect of the invention, a method for the supply of low-rank coal with reduced moisture content comprises the steps of:

storing particulate low-rank coal having had moisture content reduced

in a particulate low-rank coal storage silo;

supplying particulate low-rank coal to a conveying system entrained in a conveying gas in dense phase and thereby conveying particulate low-rank coal from the silo to a combustion site by dense phase pneumatic conveying;

providing one or more burners at the combustion site for the combustion of the coal;

directly injecting each burner separately at the combustion site with coal in dense phase.

The delivery and injection method in accordance with this aspect of the invention is in particular suited for use with the drying and transport method of the previous aspect of the invention as an integrated drying transport and combustion solution, but each method may be operated independently.

### BRIEF DESCRIPTION OF THE DRAWINGS

The invention will now be described by way of example only with reference to FIGS. 1 and 2 of the accompanying drawings in which:

FIG. 1 is a schematic of an example low-rank coal fired power plant embodying the principles of a drying transport system in accordance with the invention;

FIG. 2 is a cross-section of a dual channel pipe suitable for use in a drying transport system in accordance with the invention.

### DETAILED DESCRIPTION

Preferred features of the invention and its use are exemplified below with reference to an example low-rank coal fired power plant but the principle of the invention is applicable to all the thermal plants using high moisture coal including integrated gasification combined-cycle plants or oxyfuel plants and can additionally be extended to other plant where a requirement arises for drying lower class coals, whether for use in a combustion apparatus or otherwise, especially where it is desirable to provide a combined low-rank coal drying and transportation process. The embodiment employs steam trace heating for drying, but other drying fluids or sources of heat may be considered without departing from the principle of a combined low-rank coal indirect drying and transportation process.

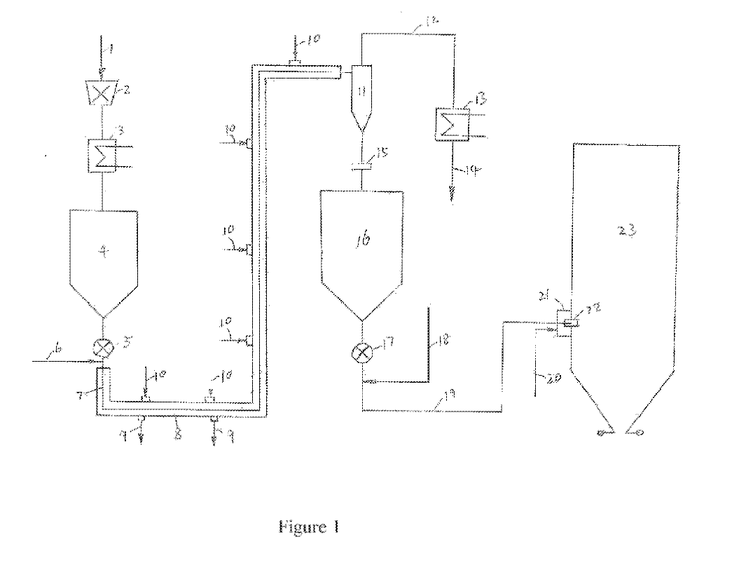

In the simple schematic of FIG. 1 a single example of each apparatus/stage is shown for simplicity, but it will be understood that some items of apparatus may more conveniently be provided plurally.

In typical operation of the invention in association with the example low-rank coal fired power plant, raw coal 1 is pulverized at a milling plant 2 at a coal yard. The coal yard may be remote from the plant. Thus, the pulverization may take place remote from the plant. The distance from the coal yard to the plant provides a length over which the low-rank coal is dried. A distance to the plant is ideally not greater than 5 km. If the distance to plant is too small to provide the required length pipes might double back to give the required length over which the low-rank coal is dried.

It is preferred that the hammer mills are employed for the energy effective graining and screening process. Various types of crashers can also be employed work together with hammer mills for the pulverizing process if it is found more effective. For enlarging the specific surface of the particles for an enhanced drying process, it is preferred that the required fineness for the combustion process is achieved at the milling plant. No further milling is then necessary downstream of the pneumatic conveyor/dryer of the invention.

A particulate fuel pre-dryer 3 may also be used, if it is needed, to ensure the low-rank coal particles are dry enough for pneumatic conveying. This pre-drying is only a limited drying, and in particular is primarily a surface drying, and does not depart from the general principle of the invention that the bulk of the drying is carried out within a combined dryer and conveyor.

In a thermal power plant a low temperature low grade heat resource should be considered for the pre-drying process if applicable. A cost effective mean to recover the latent heat of the vapour generated in the pre-drying process may also need to be implemented.

Alternatively where coarser grinding is deemed more beneficial in starting pneumatic conveying of wet pulverized low-rank coal, the fine graining for combustion can be achieved by further milling apparatus downstream, for example at the transit station, to achieve the required fineness for optimization of the combustion process.

The pulverised low-rank coal may be held prior to transport in silos 4.

The pulverised low-rank coal will be transported from the milling plant 2 at the coal yard to PF silos 16 at a transit station on the way to the boiler plants by a pneumatic conveying system with steam trace heating embodying the principles of the first aspect of the invention. No dust will be generated from the pneumatic conveying system as all the equipment is fully sealed. The transport pipes can be arranged in any angles even vertically; the pipes can be laid on the ground level or in the trench as well as vertically attached to the walls or columns. The enclosed incline bridges for supporting and housing the conveying belts are no longer needed at all.

In the embodiment, a gas stream 6 with the required pressure and quantity entrains PF from a bulk feeder 5 and is introduced to a transport pipe 7. For the potential conveying distance and the steam pressure applied, pressure vessels should be the preferred bulk solid feeders. The gas stream 6 provides the energy source for the fluidization and transportation of the particles. For maintaining an inert-atmosphere and recovering the latent heat of the vapour generated in the drying process, steam is the preferred transport gas for this application. Another significant advantage for using steam as the transport gas is that the pressure and temperature of steam can be generated in a boiler with the support of a feed pump so that the costly compressors can be avoided. The heat transfer coefficients between the gas, solid and pipe wall are much enhanced by using fluidised gas/solid flows.

Drying gas is supplied via inlets 10 to trace heating pipe(s) 8 surrounding the transporting pipe(s). If steam trace heating is applied to the outer wall of the transporting pipes, it is possible to integrate the drying process of the wet pulverized low-rank coal with the pneumatic conveying process.

Superheated steam with a pressure of 2˜30 Bar should be used as the conveying medium at the start point of the conveying process. The pressure of the transport steam/particulate stream reduces alone the transporting pipe. The outer heating steam pressure should always be higher than that of the inner transport steam at the same location as higher pressure means higher saturation temperature so as to provide the energy for drying process. The pressure differentials of two steam streams should be optimised to ensure the adequate temperature differentials for achieving the expected coal drying rates at the same time to ensure an optimised plant thermal efficiency. To effect this in the embodiment, steam is supplied via inlets 10 along the length of the trace heating pipe(s) 8.

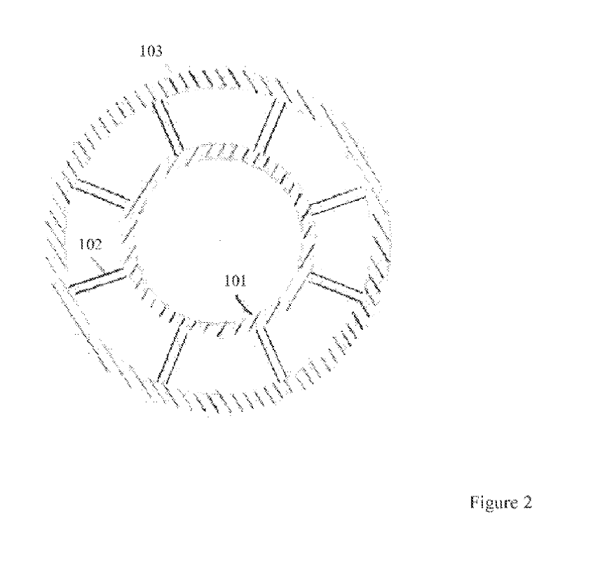

In a preferred arrangement shown in cross-section in FIG. 2 the heating steam pipe 103 may be installed as a sleeve pipe around the transport pipe 101 so that an appropriate channel can be reserved for heating steam flows. For keeping the space between the inner transport pipe and the outer heating steam pipe, pins 102 are welded to the outer surface of the inner transport pipe. The pins are also beneficial in boosting heat transfer as part of the heat transfer surface. The heat transfer surface comprises a condensation surface on which steam in the outer heating steam pipe may condense provided an over-pressure in the outer heating steam pipe and consequent higher saturation temperature is maintained. As a result, the heat transfer process is particularly efficient, and involves a large degree of transfer of latent heat from the heating steam. Gaps between the pins 102 allow condensate to fall through for removal to a sump.

The thermal efficiency of the drying process is potentially high, with drying taking place in a very highly turbulent medium and particles being extremely fine and consequently of very large surface area on relation to the mass.

A most likely point of limitation in the thermal transfer process is therefore likely to be the transfer of thermal energy from the inner pipe and into the drying channel. The inner pipe surface area may be relatively small, and transfer is from the solid inner pipe to the fluidised gas/particulate medium in the transport channel. It is possible that measures for heat transfer enhancement may need to be implemented to the transport side of the pipe to increase the rate of heat transfer into the transport stream.

Amongst measures suitable to effect this might be:

increases in conveying steam pressure and temperature;

higher conveying steam velocity;

increases in the pressure differential of the heating steam and the conveying steam for an increased temperature differential between the two streams;

internally ribbed or rifled transport pipes;

the use of multiple parallel pipes with smaller diameters to increase the overall surface area for transfer.

Some of the disadvantages of these various approaches were discussed above.

The gaps between the pins allow the condensate to be collected and drained from the bottom of the outer heating steam pipes. The number, sizes and pitches of the pins should be carefully selected for cost effectiveness and heat transfer enhancement.

Hot wells are arranged underneath the low points of the heating steam pipe(s) 8 to collect the condensate. Drain control valves 9 can be arranged to control the water levels of the hot wells. The heating steam pipe can be split into several sections along the length of the conveying pipe so that various heating steam pressures can be applied for the individual sections of the heating steam pipe to optimise the heat transfer and the plant thermal efficiency. A steam pressure control valve can be arranged for each section to maintain the heating steam pressure.

Lower PF moisture could be achieved with a higher transporting steam temperature, which should result in a further reduction in flue gas heat losses and a better boiler thermal efficiency. It is preferred that the vapour latent heat is also recovered at the same or similar pressure to ensure the minimum losses in energy. In addition to achieving a better coal drying rate, an increased conveying steam pressure would also be very beneficial for the size reduction of the conveying and separating equipment and subsequently the cost effectiveness.

Generally there are two ways to receive steam for drying and transporting processes, using turbine inter-stage steam extraction or specially arranging some heating surface in the main boiler to generate and heat steam to the required pressure and temperature. The decision can only be made by plant thermal efficiency analysis and optimizations.

More and more steam will be generated from the drying process along the transport pipe. This will by default increase the pressure drop along the length and/or the inlet pressure required. The diameter of the transport pipe may thus be gradually enlarged to achieve the optimised steam velocities for cost and energy effectiveness.

An outlet of the pneumatic transport pipe feeds a gas solid separator 11. Both cyclones and vapour electrostatic precipitators can be used as the gas solid separators. In the embodiment a cyclone is proposed as cyclones are smaller and simpler than the precipitators which potentially provide flexibility of operating pressures. As discussed above, a higher transporting steam pressure is desirable to achieve desirable size reductions in the conveying pipes and equipment as well as achieving a higher steam temperature for the higher coal drying rates. Cyclones facilitate this. A couple of cyclones in series could be a good solution.

Exhaust transporting gas steam 12 from the separator(s) is passed to a condenser 13 to recover latent heat. Boiler feed water or combustion air could be used as the cooling medium of the condenser. The sensible heat of the condensate 14 should also be recovered through plant heat integration.

Dry pulverized low-rank coal from the separator(s) passes through a PF feeder and pressure isolator to be collected in the PF silos 16. It is preferred that the silos still remain in an inert atmosphere and are insulated so that the sensible heat of the dry pulverized low-rank coal can return to the furnace. Gas vent and dust separating apparatus for the vent may also need to be installed for the PF silos.

The dry pulverized low-rank coal is delivered to coal burners 22 of a furnace 23 by dense phase pneumatic conveying. The dry pulverized low-rank coal is directly injected to the individual coal burners 22. The dry pulverized low-rank coal is delivered to coal burners 22 upstream of and adjacent to a burner outlet. Combustion gas 20 is supplied via a windbox 21 in conventional manner. The firing system is thus an indirect firing system using dense phase pneumatic conveying of the pulverized fuel.

An inert atmosphere should still be maintained for the pneumatic conveying system if the PF temperatures are still above the safety limits. Air can also be used for conveying PF if the PF temperature is low. For a conventional boiler, flue gas could be the most convenient inert gas available for PF pneumatic conveying. However it may need to be cleaned before being used for this purpose. For an oxyfuel boiler, Nitrogen may be the best inert gas available for the conveying medium. The inert conveying medium can also be heated to further recover the waste heat of the thermal plant.

A large amount of steam will be generated in the integrated pulverized low-rank coal transport and drying process. The material to gas ratios are low at the end of the transporting pipes which would result in big pipe sizes. However the conveying pipes from the transit station to the boiler burners can be much smaller as the material to gas ratios can be very high. The pulverized low-rank coal may be conveyed via dense phase pneumatic conveying. For dense phase pneumatic conveying, both power consumption and component erosion could be very low due to the low gas velocities adopted. The location of the transit station should be optimised based on the PF moisture content, cost of the drying and conveying pipes and cost of the pressure generators for conveying PF to the boiler burners.

Conventionally PF is pneumatically conveyed to boiler burners in lean phase. The diameters of PF pipes are as large as 400˜600 mm. The costs of the PF pipes including the supports for the piping are significant. These PF pipes occupy large space and cause difficulties to layout around burner areas. Large primary air (PA) fans are typically required.

With the dense phase pneumatic conveying in the redesigned system enabled by the embodiment of the present invention, the diameters of PF pipes are as small as 30˜80 mm. The pulverizer is at the coal yard not the boiler. Large PA fans may not be necessary. Air can be provided by the forced draft (FD) fans. All this may result in significant cost reductions and much more desirable free space around the burner area for maintenance.

In the embodiment the combustion air 20 is supplied by FD fans and heated to the desirable temperatures before entering boiler burners. No primary air fans are required. The burners are designed to have the desirable air splits between the primary, secondary, tertiary and quaternary air nozzles. The highly concentrated PF flows will be injected into the respective PA streams before spouting into the furnace via the PF nozzles. The PF injection device may also need to be designed to ensure the good mixing between the PF flows and the primary air streams.

Most coal fired power plants are designed with direct firing systems, for which the conveying gas flow is very much restricted by the required gas flow for combined milling and drying process. With the PF injection system illustrated, primary air ratios are much more flexible for achieving better combustion and lower emissions.

The invention comprises a new process system for low-rank coal grinding, drying and conveying. In consequence, the invention enables significant changes to the design concept of a low-rank coal plant. Compared with a conventional low-rank coal plant for example with the WTA technology described above, advantages in such a plant may include the following:
1. Cost savings from integration of the PF conveying and drying processes.
2. Smaller equipment and components with a pressurised integrated PF drying and conveying system.
3. Potential further improvements of at least 1-2% in plant thermal efficiency as a lower PF moisture can be achieved with a higher drying medium temperature.
4. Cost saving by replacing the enclosed incline bridge used for supporting and housing coal conveying belts in a conventional plant by the integrated PF drying and conveying system.
5. A common milling plant and an integrated drying and conveying system could be shared by all the units of the thermal plant. The margin of the equipments can be minimised.
6. The sizes of the raw coal silos and the wet pulverized low-rank coal silos could be minimised as the milling plant is located at the coal yard.
7. No coal preparing equipment is needed at the boiler plants which would provide flexibilities in plant general layout potentially result in shorter main service pipes between the boilers and the turbines consequently lower costs and higher plant efficiencies.
8. Cost and space reductions may be achieved as a consequence of very small PF pipes used for dense phase PF conveying to the boiler front.
9. No primary air fan is required as highly concentrated PF flows could be injected into primary air streams supplied by forced draft fans before spout into the furnace from primary air nozzles.
10. Reduced energy consumptions may follow from the dense phase conveying.
11. Low component erosion may follow from the low gas velocities for dense phase conveying.

### LIST OF REFERENCE NUMERALS

1. Raw Coal
2. Mill
3. Particulate Fuel Pre-dryer
4. Particulate Fuel Silo
5. Bulk Feeder
6. Conveying Gas
7. Pneumatic conveying pipe
8. Trace Heating Pipe
9. Drains
10. Heating Gas
11. Gas Solid Separator
12. Separated Conveying Gas
13. Condenser
14. Condensate
15. Dry PF feeder and Pressure Isolator
16. Dry PF Silo
17. Dry PF Feeder
18. Conveying Gas
19. Pneumatic Conveying Pipe
20. Combustion Air
21. Windbox
22. Burner
23. Furnace
101. Conveying Pipe
102. Pins
103. Trace Heating Pipe

1. An apparatus for the processing of low-rank coal to remove moisture content therefrom comprising:
a first pipe having an inner wall surface surroundingly defining a first flow channel and an outer wall surface;
a low-rank coal supply system to supply particulate low-rank coal to an inlet of the first flow channel;
a transport gas supply to supply transport gas to an inlet of the first flow channel;
a heating apparatus comprising a source of heat and a means to apply the heat to an outer wall surface of the first pipe along at least part of the length thereof.

2. An apparatus in accordance with claim 1 comprising a first pipe having an inner wall surface surroundingly defining a first flow channel and an outer wall surface;
the first flow channel having an inlet at a first end in the vicinity of a low-rank coal supply source and an outlet at a second end in the vicinity of a low-rank coal delivery site remotely spaced some distance therefrom;
a transport gas supply to supply transport gas to an inlet of the first flow channel and convey the same to an outlet remotely spaced therefrom;
a heating apparatus comprising a source of heat and a means to apply the heat to an outer wall surface of the first pipe along at least part of the length between the inlet and the outlet so as to effect drying of the particulate low-rank coal as it is conveyed from the first end to the second end.

3. An apparatus in accordance with claim 1 wherein the heating apparatus comprises a drying fluid supply to supply a drying fluid as a source of thermal energy, configured such that a drying fluid is brought into contact with the outer wall surface of the first pipe along at least part of the length thereof.

4. An apparatus in accordance with claim 3 wherein the drying fluid supply comprises a drying fluid conduit adapted to cause drying fluid to flow over the outer wall surface of the first pipe along at least a part of its length and a drying fluid source supply to supply a drying fluid to at least an inlet of the drying fluid conduit.

5. An apparatus in accordance with claim 3 wherein the drying fluid supply comprises:
a second pipe surroundingly disposed around the first such that an inner wall of the second pipe and an outer wall of the first pipe together define a second flow channel;
a drying fluid source supply to supply a drying fluid to at least an inlet of the second flow channel.

6. An apparatus in accordance with claim 5 wherein the apparatus comprises a first closed pipe and a second closed pipe, each pipe has a continuous closed inner wall surface to define an inner pipe volume, the inner pipe volume defines a first flow channel; and the first pipe lies entirely within the volume defined by the inner wall surface of the second pipe, the inner wall surface of the second pipe and the outer wall surface of the first pipe together defining at least one second flow channel disposed outside and around the first flow channel.

7. An apparatus in accordance with claim 3 wherein the drying fluid supply is a gas supply.

8. An apparatus in accordance with claim 7 wherein the drying gas supply is a steam supply.

9. An apparatus in accordance with claim 1 wherein the transport gas supply is a steam supply.

10. An apparatus in accordance with claim 9 adapted to maintain pressure of the drying gas higher than the pressure of the transport gas so that the steam saturation temperature of the drying gas is higher.

11. An apparatus in accordance with claim 8 wherein the steam supply is a supply of steam from a thermal power plant.

12. An apparatus in accordance with claim 8 wherein the drying fluid supply apparatus comprises a plurality of successive drying fluid supply modules disposed successively along the length of the fluidly continuous inner pipe, adapted for successively reduced pressure of operation.

13. An apparatus in accordance with claim 1 comprising inlet means to the or each respectively defined flow channel at an inlet end of the apparatus and outlet means at a remotely spaced outlet end.

14. An apparatus in accordance with claim 13 wherein the inlet means are adapted to receive supply of low-rank coal to be dried from a supply source and the outlet means are located to deliver dried low-rank coal to a delivery site for further processing and wherein the supply source is remotely located some substantial distance from the delivery site for example in another part of the plant.

15. An apparatus in accordance with claim 1 comprising an elongate process flow channel that is at least 100 m long.

16. An apparatus in accordance with claim 1 comprising a system to recover latent heat from the transport gas recovered at a transport gas outlet of the first flow channel remotely spaced from the transport gas inlet of the first flow channel.

17. An apparatus in accordance with claim 1 wherein the cross-sectional area of the first pipe changes from a smaller cross-sectional area towards an inlet end to a larger cross-sectional area towards an outlet end.

18. An apparatus in accordance with claim 1 wherein wall surfaces of the first pipe are modified by provision of heat transfer structures which act to increase the surface area for heat transfer.

19. An apparatus in accordance with claim 1 disposed both as a means to effect drying of the low-rank coal and as a means to convey the low-rank coal from a supply source to a delivery site remotely located a substantial distance from the supply source.

20. A processing system for processing low rank coal to remove moisture content therefrom and simultaneously convey the same for a substantial part of the distance from a low-rank coal supply system to a remote delivery site comprising an apparatus in accordance with claim 1 adapted to transport the particulate low-rank coal from the low-rank coal supply system to a remote delivery site.

21. A processing system for processing low rank coal comprising an apparatus as in accordance with claim 1 defining a first flow channel in which low-rank coal is processed, the first flow channel having an inlet at a first end and an outlet at a second end remotely spaced therefrom;
a low-rank coal supply system to supply particulate low-rank coal to an inlet of the first flow channel;
a low-rank coal delivery system to receive dried particulate low-rank coal from an outlet of the first flow channel.

22. A processing system for processing low rank coal comprising:
a mill to convert low-rank coal into particulate form for transport;
a transit station including a particulate low-rank coal storage silo, located remotely from the mill;
an apparatus in accordance with claim 1 adapted to transport the particulate low-rank coal from the mill to the transit station.

23. A processing system in accordance with claim 22 wherein mill is located at a coal yard remote from combustion or other processing site, the transit station is located more closely adjacent to the combustion or other processing site; and the apparatus in accordance with claim 1 is thus adapted to transport the particulate low-rank coal from a mill at a coal yard remote from the combustion or other processing site towards the combustion or other processing site.

24. A processing system in accordance with claim 20 further comprising, downstream of the apparatus in accordance with claim 1:
a separator to separate particulate low-rank coal for storage from transport gas;
a recovery conduit for recovery of transport gas.

25. A processing system in accordance with claim 24 further comprising a heat recovery system to recover latent heat from the transport gas.

26. A processing system in accordance with claim 25 wherein the heat recovery system comprises a condenser.

27. A processing system in accordance with claim 25 forming part of a thermal power plant, wherein the heat recovery system recovers heat to the boiler feedwater or combustion air.

28. A processing system in accordance with claim 20 adapted for drying of low-rank coal via steam trace heating.

29. A processing system in accordance with claim 28 forming part of a thermal power plant and comprising a steam supply conduit to supply steam from a low grade source in the thermal power plant as a drying gas for the apparatus to transport the particulate low-rank coal.

30. A processing system in accordance with claim 29 comprising a steam supply conduit to supply steam from a low grade source in the thermal power plant as a transport gas for the apparatus to transport the particulate low-rank coal.

31. A processing system in accordance with claim 20 further including, downstream of the particulate low-rank coal storage silo, a means to transport the dried particulate low-rank coal to a combustion site for combustion, and one or more burners at the combustion site for the combustion of the coal.

32. A processing system in accordance with claim 31 wherein the system further includes, downstream of the particulate low-rank coal storage silo, a conveying conduit; and a conveying gas supply system to supply conveying gas to the conveying conduit in such manner as to entrain particulate low-rank coal and convey the same from the low-rank coal storage to a process site such as a combustion site for combustion.

33. A combustion apparatus for the combustion of low-rank coal supplied by an apparatus or system in accordance with claim 1.

34. A steam generator wherein the means to generate steam comprises a combustion apparatus or system in accordance with claim 33.

35. A thermal power generation plant including one or more steam generators in accordance with claim 34.

36. A pulverized fuel delivery and burner injection system comprising:
a particulate low-rank coal storage silo;
a dense phase pneumatic conveyor system to convey particulate low-rank coal from the silo to a combustion site in dense phase;
one or more burners at the combustion site for the combustion of the coal;
a burner fuel injection system to supply each burner separately with coal at the combustion site from the dense phase conveyor system by direct injection.

37. A delivery and injection system in accordance with claim 36 adapted to transport fuel to the burners entrained in a conveying gas via a conveying system comprising one or more conveying conduits.

38. A delivery and injection system in accordance with claim 36 adapted to transport fuel to the burners at gas to fuel ratios in the range between 1 to 5 and 1 to 45 by weight.

39. A delivery and injection system in accordance with claim 36 wherein the or each conveying conduit has a diameter of less than 200 mm.

40. A delivery and injection system in accordance with claim 39 wherein the or each conveying conduit has a diameter of between 30 and 80 mm.

41. A delivery and injection system in accordance with claim 36 having a conveying system comprising in fluid series: an upstream conveying conduit; a distributor comprising a pressure vessel with an inlet to receive fuel from the upstream conveying conduit and a plurality of outlets serving a corresponding plurality of downstream conveying conduits, each downstream conveying conduit having a fuel injection apparatus to inject fuel into one or more burners.

42. A delivery and injection system in accordance with claim 36 comprising a windbox for the supply of combustion air and provided with forced draft fans as the sole means to deliver air to the windbox and not provided with separate primary air fans.

43. A processing system in accordance with claim 19 in combination with a delivery and injection system in accordance with claim 36.

44. The use of an apparatus in accordance with claim 1 to remove moisture content from low-rank coal while transporting the low-rank coal from a source site to a supply site.

45. The use of an apparatus in accordance with claim 1 to remove moisture content from low-rank coal while transporting the low-rank coal from a milling plant at a coal yard to a remote combustion site.

46. A method for the processing of low-rank coal to remove moisture content therefrom comprising the steps of:
supplying particulate low-rank coal to an inlet of a first pipe having an inner wall surface surroundingly defining a first flow channel and an outer wall surface;
supplying a transport gas to an inlet of the first flow channel such as to cause the particulate low-rank coal to fluidize and flow along the first flow channel;
applying thermal energy to the outer wall surface of the first pipe along at least part of the length thereof such that transfer of thermal energy across the wall of the first pipe into the first flow channel tends to dry the particulate low-rank coal in the first flow channel.

47. A method in accordance with claim 46 wherein the step of applying thermal energy comprises causing a drying fluid to contact with and for example flow over the outer wall surface of the first pipe along at least part of the length thereof under such thermodynamic conditions that thermal transfer from the drying fluid across the wall of the first pipe into the first flow channel from sensible and/or latent heat in the drying fluid tends to dry the particulate low-rank coal in the first flow channel.

48. A method in accordance with claim 47 wherein the step of applying thermal energy comprises the step of supplying a drying fluid to a second flow channel surroundingly disposed around the first pipe under such thermodynamic conditions that thermal transfer from the fluid in the second flow channel across the wall of the first pipe into the first flow channel tends to dry the particulate low-rank coal therein.

49. A method in accordance with claim 46 for the processing of low-rank coal to remove moisture content therefrom and simultaneously conveying the same from a supply source to a delivery site, in particular remotely located some distance from the supply source, the method comprising the steps of:
supplying particulate low-rank coal to an inlet of a first pipe having an inner wall surface surroundingly defining a first flow channel and an outer wall surface;
supplying a transport gas to an inlet of the first flow channel such as to cause the particulate low-rank coal to fluidize and flow along the first flow channel towards an outlet at a second end remotely spaced therefrom;
applying thermal energy to the outer wall surface of the first pipe along at least part of the length thereof such that transfer of thermal energy across the wall of the first pipe into the first flow channel tends to dry the particulate low-rank coal in the first flow channel as it moves along the first flow channel from the inlet to the outlet.

50. A method for the supply for combustion of low-rank coal with reduced moisture content comprises the steps of:
storing particulate low-rank coal having had moisture content reduced in a particulate low-rank coal storage silo;
supplying particulate low-rank coal to a conveying system entrained in a conveying gas in dense phase and thereby conveying particulate low-rank coal from the silo to a combustion site by dense phase pneumatic conveying;
providing one or more burners at the combustion site for the combustion of the coal;
directly injecting each burner separately with coal at the combustion site with coal in dense phase.

51. A method for the processing of low-rank coal to remove moisture content therefrom and for the supply of the same for combustion comprising the method of claim 46 in combination with the method of claim 50.
